(19) United States
(12) Patent Application Publication
(10) Pub. No.: US 2014/0064490 A1
(43) Pub. Date: Mar. 6, 2014

(54) MANAGEMENT OF ENCRYPTION KEYS FOR BROADCAST ENCRYPTION AND TRANSMISSION OF MESSAGES USING BROADCAST ENCRYPTION

(71) Applicant: SAMSUNG ELECTRONICS CO., LTD., Suwon-si (KR)

(72) Inventors: WEIXIN WANG, Suwon-si (KR); HYOUNG-SUK JANG, Suwon-si (KR); HEE-CHANG CHO, Seoul (KR)

(73) Assignee: SAMSUNG ELECTRONICS CO., LTD., Suwon-si (KR)

(21) Appl. No.: 14/011,792

(22) Filed: Aug. 28, 2013

(30) Foreign Application Priority Data
Aug. 28, 2012 (KR) 10-2012-0094394

(51) Int. Cl. H04L 9/08

(52) U.S. Cl. CPC H04L 9/0819
USPC 380/278

(57) ABSTRACT

A method of managing keys for broadcast encryption comprises identifying a plurality of devices as corresponding to a plurality of leaf nodes in a tree structure comprising a plurality of nodes having a root node, a plurality of middle nodes, and the leaf nodes, the plurality of middle nodes comprising first middle nodes and second middle nodes, determining node key sets for the second middle nodes and for the leaf nodes and omitting a determination of node key sets for first middle nodes of the middle nodes, and determining device keys for the plurality of devices based on the node key sets for the second middle nodes and the node key sets for the leaf nodes.

### CROSS-REFERENCE TO RELATED APPLICATION

This application claims priority under 35 USC §119 to Korean Patent Application No. 2012-0094394 filed on Aug. 28, 2012, the subject matter of which is hereby incorporated by reference.

### BACKGROUND OF THE INVENTION

Embodiments of the inventive concept relate generally to broadcast encryption, and more particularly to techniques for managing encryption keys for broadcast encryption and transmitting messages using broadcast encryption.

Broadcast encryption is a technique for distributing secured data to authorized users, usually over an insecure broadcast channel. It allows a broadcast center to deliver secured data to a potentially changing set of authorized users in such a way that only the authorized users can recover the data. Broadcast encryption has been applied in a variety of content delivery systems, such as pay-television and streaming audio/video. It has also been applied to devices such as secure flash memory cards.

During typical operation of a broadcast encryption system, a broadcast center transmits a list of authorized users, a header, and an encrypted message over the broadcast channel. Each authorized user stores a device key, and it uses the device key to restore a message encryption key from the header and then decrypt the encrypted message using the restored message encryption key. In general, the management of information used in the broadcast encryption scheme can consume significant system resources. Accordingly, improvement of relevant management techniques may potentially improve system performance.

### SUMMARY OF THE INVENTION

In one embodiment of the inventive concept, a method of managing keys for broadcast encryption comprises identifying a plurality of devices as corresponding to a plurality of leaf nodes in a tree structure comprising a plurality of nodes having a root node, a plurality of middle nodes, and the leaf nodes, the plurality of middle nodes comprising first middle nodes and second middle nodes, determining node key sets for the second middle nodes and for the leaf nodes and omitting a determination of node key sets for first middle nodes of the middle nodes, and determining device keys for the plurality of devices based on the node key sets for the second middle nodes and the node key sets for the leaf nodes.

In another embodiment of the inventive concept, a system configured to manage keys for broadcast encryption comprises a tree structure comprising a plurality of nodes having a root node, a plurality of middle nodes, and a plurality of leaf nodes, the plurality of middle nodes comprising first middle nodes and second middle nodes, a plurality of devices corresponding to the plurality of leaf nodes, a controller configured to determine node key sets for the second middle nodes and for the leaf nodes, to omit a determination of node key sets for first middle nodes of the middle nodes, and to determine device keys for the plurality of devices based on the node key sets for the second middle nodes and the node key sets for the leaf nodes.

These and other embodiments can potentially improve the performance of a system using broadcast encryption by reducing the amount of data to be generated and managed for the broadcast encryption.

### BRIEF DESCRIPTION OF THE DRAWINGS

The drawings illustrate selected embodiments of the inventive concept. In the drawings, like reference numbers indicate like features.

FIG. 1 is a flowchart illustrating a method of managing keys for broadcast encryption according to an embodiment of the inventive concept.

FIG. 2 is a diagram illustrating an example tree structure for the method of FIG. 1, according to an embodiment of the inventive concept.

FIG. 3 is a diagram for describing an operation 5300 in the method of FIG. 1, according to an embodiment of the inventive concept.

FIG. 4 is another diagram for describing operation 5300 in the method of FIG. 1, according to an embodiment of the inventive concept.

FIG. 5 is another diagram for describing operation 5300 in the method of FIG. 1, according to an embodiment of the inventive concept.

FIG. 6 is another diagram for describing operation 5300 in the method of FIG. 1, according to an embodiment of the inventive concept.

FIG. 7 is a diagram illustrating another example tree structure for the method of FIG. 1, according to an embodiment of the inventive concept.

FIG. 8 is a diagram for describing the method of FIG. 1, according to an embodiment of the inventive concept.

FIG. 9 is another diagram for describing the method of FIG. 1, according to the embodiment of FIG. 8.

FIG. 10 is another diagram for describing the method of FIG. 1, according to the embodiment of FIG. 8.

FIG. 11 is a diagram for describing the method of FIG. 1, according to another embodiment of the inventive concept.

FIG. 12 is a diagram for describing the method of FIG. 1, according to the embodiment of FIG. 11.

FIG. 13 is a diagram for describing the method of FIG. 1, according to the embodiment of FIG. 11.

FIG. 14 is a flowchart illustrating a method of transmitting messages using broadcast encryption, according to an embodiment of the inventive concept.

FIG. 15 is a block diagram illustrating a broadcast encryption device, according to an embodiment of the inventive concept.

FIG. 16 is a block diagram illustrating a broadcast decryption device, according to an embodiment of the inventive concept.

### DETAILED DESCRIPTION

Embodiments of the inventive concept are described below with reference to the accompanying drawings. These embodiments are presented as teaching examples and should not be construed to limit the scope of the inventive concept.

In the description that follows, the terms first, second, etc. may be used to describe various elements, but the described elements should not be limited by these terms. Rather, these terms are used to distinguish one element from another. For example, a first element could be termed a second element, and, similarly, a second element could be termed a first element, without departing from the scope of the inventive concept. As used herein, the term “and/or” includes any and all combinations of one or more of the associated listed items.

Where an element is referred to as being “connected” to another element, it can be directly connected to the other element or intervening elements may be present. In contrast, where an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the inventive concept. As used herein, the singular forms “a,” “an” and “the” are intended to encompass the plural forms as well, unless the context clearly indicates otherwise. Terms such as “comprises,” “comprising,” “includes” and/or “including,” where used herein, indicate the presence of stated features but do not preclude the presence or addition of one or more other features.

Unless otherwise defined, all terms (including technical and scientific terms) used herein have the same meaning as commonly understood by one of ordinary skill in the art to which this inventive concept belongs. Terms such as those defined in commonly used dictionaries should be interpreted as having a meaning that is consistent with their meaning in the context of the relevant art and will not be interpreted in an idealized or overly formal sense unless expressly so defined herein.

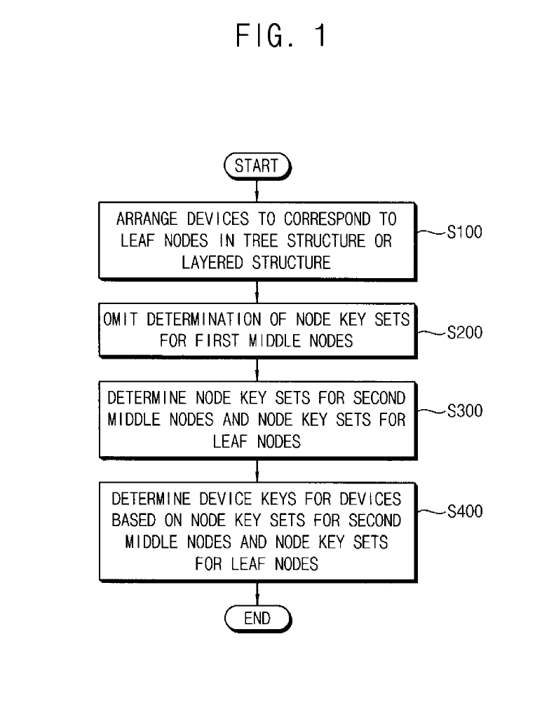

FIG. 1 is a flowchart illustrating a method of managing keys for broadcast encryption, according to an embodiment of the inventive concept.

Referring to FIG. 1, the method comprises arranging a plurality of devices to correspond to a plurality of leaf nodes in a tree structure (or layered structure) (S 100). The tree structure comprises a plurality of nodes including a root node, a plurality of middle nodes, and the leaf nodes. The tree structure is typically a data structure, i.e., a virtual structure, and the arrangement of devices into leaf nodes typically comprises configuring the data structure so that the devices are treated logically as leaf nodes. In the tree structure, the root node is disposed at a top level and may correspond to a host (e.g., a provider or a broadcasting center) that supplies messages and/or contents. The leaf nodes are disposed at the bottom of the tree structure and may correspond to users that receive the messages and/or the contents.

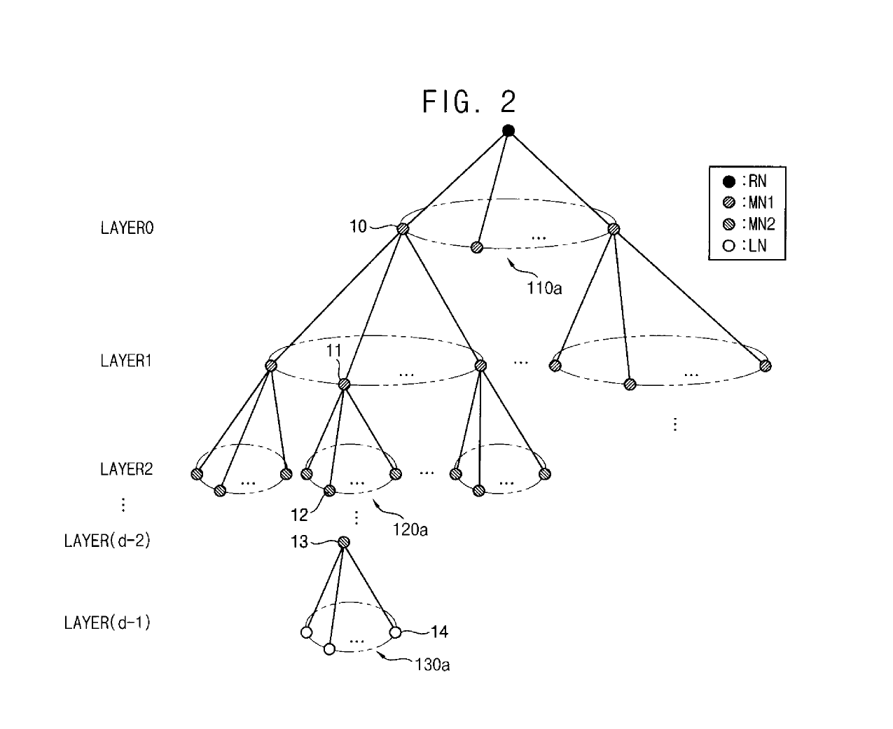

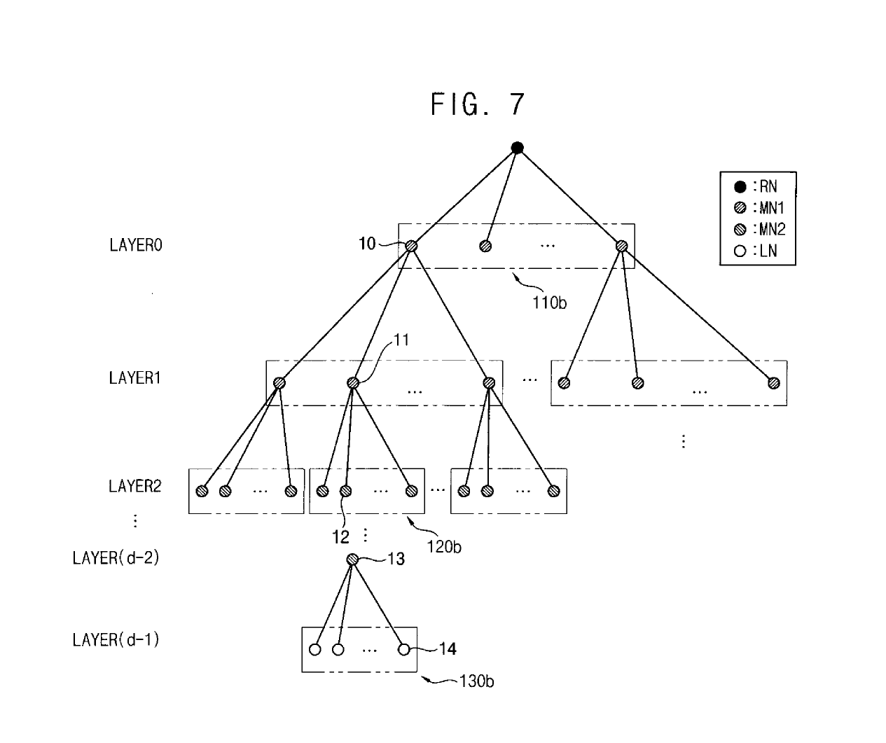

FIGS. 2 and 7 illustrate alternative configurations for nodes in the tree structure of FIG. 1. The configurations of FIGS. 2 and 7 are similar, except that in the configuration of FIG. 2, nodes are organized into node groups having a circular configuration, and in the configuration of FIG. 7, nodes are organized into node groups having a linear configuration. These configurations will be described in further detail below.

Referring again to FIG. 1, the method proceeds without determining node key sets for first middle nodes among the middle nodes (S200). In other words, the method omits a determination of node key sets for the first middle nodes. In addition to operation S200, the method determines node key sets for second middle nodes among the middle nodes and for the leaf nodes (S300). The term “first middle nodes”, as used herein, refers to nodes having a distance (or depth) from the root node that is less than some predetermined number. By contrast, the term “second middle nodes”, as used herein, refers to nodes having a distance from the root node that is greater than or equal to the predetermined number.

As a result of operations S200 and S300, some nodes in the tree structure have node key sets and other nodes in the tree structure do not have node key sets. As illustrated in FIGS. 2 and 7, for instance, the first middle nodes are disposed in an upper portion of the tree structure and the second middle nodes are disposed in a lower portion of the tree structure.

Device keys for the devices are determined based on the node key sets for the second middle nodes and the node key sets for the leaf nodes (S400). For example, where a first device among the devices corresponds to a first leaf node among the leaf nodes, a first device key for the first device may be generated based on a first node key set and second node key sets. The first node key set may be a node key set for the first leaf node. The second node key sets may be node key sets for first ancestor nodes of the first leaf node. The first ancestor nodes may be in the second middle nodes and may not be in the first middle nodes.

In a conventional method of managing keys for broadcast encryption, all nodes in a tree structure have node key sets, respectively, and a device key for a device is determined based on node key sets for all ancestor nodes corresponding to the device. Thus, device keys have relatively large sizes and a broadcast encryption system requires a device key storage device having relatively large capacity in the conventional method of managing keys for broadcast encryption.

By contrast, in the method of FIG. 1, determination of the node key sets for the first middle nodes is omitted, so only the node key sets for the second middle nodes and the node key sets for the leaf nodes are determined, and the device keys are determined based on the node key sets for the second middle nodes and the node key sets for the leaf nodes. Accordingly, the device keys may have relatively small sizes and a device key storage device in a broadcast encryption system may have relatively small capacity. Messages may be effectively transmitted from the host (e.g., the provider) to the device (e.g., the user) in the broadcast encryption system based on the device keys having relatively small sizes.

FIG. 2 is a diagram illustrating an example tree structure for the method of FIG. 1, according to an embodiment of the inventive concept. More specifically, FIG. 2 illustrates an example tree structure where nodes in the same node group are configured in a circular configuration.

Referring to FIGS. 1 and 2, the tree structure comprises a root node RN, a plurality of middle nodes and a plurality of leaf nodes LN. The middle nodes include first middle nodes MN1 and second middle nodes MN2. The tree structure comprises a plurality of layers LAYER0, LAYER1, LAYER2, . . . , LAYER(d−2), LAYER(d−1). A depth of the tree structure corresponds to a level of the tree structure except for root node RN, and may correspond to the number of the layers LAYER0, . . . , LAYER(d−1). The total depth of the tree structure of FIG. 2 is “d”. In other words, the number of layers LAYER0, . . . , LAYER(d−1) in the tree structure of FIG. 2 is “d”.

Layers LAYER0, . . . , LAYER(d−1) are organized into node groups 110a, 120a, 130a. Each of node groups 110a, 120a, 130a comprises at least two of middle nodes MN1, MN2 and leaf nodes LN. Node groups 110a, 120a, 130a have the same number of nodes, i.e., “t” nodes. First nodes in the same node group are in the same layer, and the same ancestor nodes are shared by the first nodes in the same node group. For example, node group 110a may comprise “t” first middle nodes MN1 in first layer LAYER0, and root node RN may be shared by the “t” first middle nodes MN1 in node group 110a. Node group 120a may comprise “t” second middle nodes MN2 in third layer LAYER2, and root node RN and first middle nodes 10, 11 may be shared by “t” second middle nodes MN2 in node group 120a. Node group 130a may comprise “t” leaf nodes LN in the d-th layer LAYER(d−1), and root node RN, first middle nodes 10, 11 and second middle nodes 12, 13 may be shared by “t” leaf nodes LN in node group 130a.

In some embodiments, where a single node group comprises “t” nodes, first layer LAYER0 comprises “t” nodes, second layer LAYER1 comprises t² nodes, and the d-th layer LAYER(d−1) comprises t^{d} nodes. Under these circumstances, t^{d} devices can be arranged to correspond to leaf nodes LN. For example, if “t” is 16 and “d” is 10, the broadcast encryption system having the tree structure of FIG. 2 may include about 16¹⁰ devices.

In some embodiments, nodes in the same node group are disposed in a circular configuration, as illustrated in FIG. 2, and in some other embodiments, nodes in the same node group are disposed in a linear configuration, as illustrated in FIG. 7.

In some embodiments, layers LAYER0, . . . , LAYER(d−1) comprise at least one upper layer adjacent to root node RN and lower layers below at least one upper layer. First middle nodes MN1, which are omitted the determination of the node key sets, may be in the at least one upper layer, and second middle nodes MN2, which are determined the node key sets, may be in the lower layers. For example, in the tree structure of FIG. 2, the first middle nodes MN1 may be in first and second layers LAYER0, LAYER1, second middle nodes MN2 may be in the third through (d−1)-th layers LAYER2, . . . , LAYER(d−2), and leaf nodes LN may be in the d-th layer LAYER(d−1). In other words, in the tree structure of FIG. 2, the determination of node key sets for first middle nodes MN1 in layers LAYER0, LAYER1 may be omitted, and layers LAYER0, . . . , LAYER(d−1) may be classified into two upper layers LAYER0, LAYER1 and (d−2) lower layers LAYER2, . . . , LAYER(d−1).

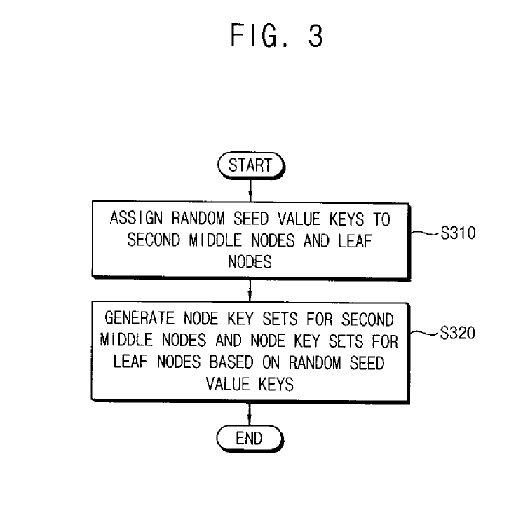

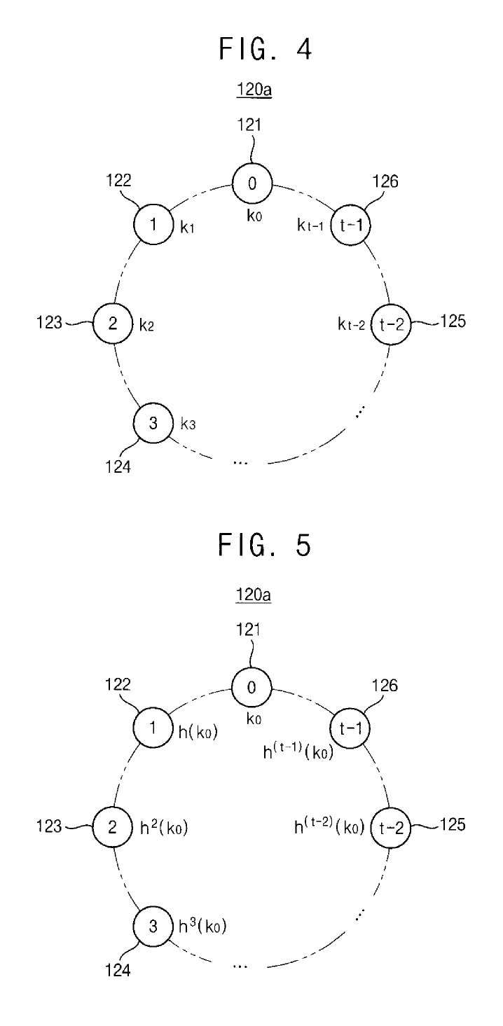

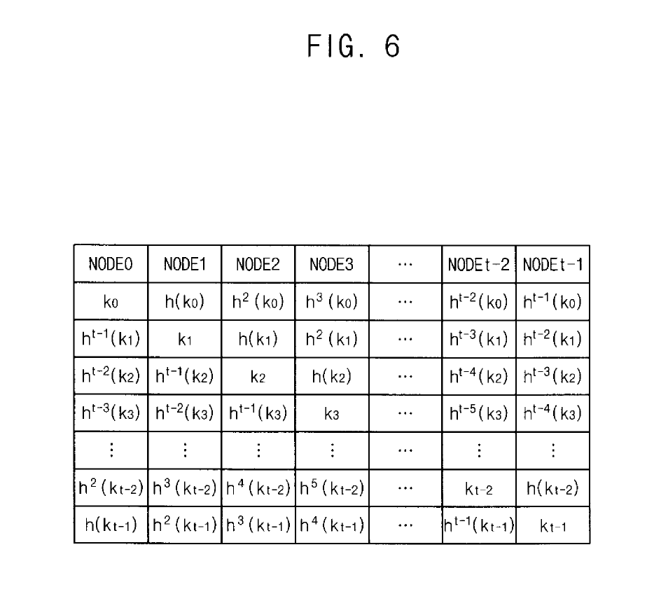

FIGS. 3, 4, 5 and 6 are diagrams for describing operation 5300 in FIG. 1. In particular, FIG. 3 is a flowchart illustrating an example of the operation 5300 in FIG. 1, FIGS. 4 and 5 illustrate an example of a node group in the tree structure of FIG. 2, and FIG. 6 is a table illustrating an example of node key sets that are determined by a scheme described with reference to FIGS. 3, 4 and 5.

Referring to FIGS. 1 and 3, in operation 300, random seed value keys are assigned to the second middle nodes and the leaf nodes, respectively (S310). The node key sets for the second middle nodes and the node key sets for the leaf nodes are generated based on the random seed value keys (S320).

Referring to FIGS. 2, 3, 4 and 5, nodes in the same node group are arranged in the circular configuration. Operations 5310 and 5320 will be described based on determining the node key sets for second middle nodes MN2 in node group 120a in lower layers LAYER2, . . . , LAYER(d−1).

In the example of FIG. 4, node group 120a comprises “t” second middle nodes 121, 122, 123, 124, 125, 126 that are disposed in the circular configuration. Random seed value keys k₀, k₁, k₂, k₃, . . . , kₜ₋₂, kₜ₋₁ are assigned to the second middle nodes 121, . . . , 126, respectively. More specifically, a first random seed value key k₀ is assigned to a first node 121 in node group 120a, a second random seed value key k₁ is assigned to a second node 122 in node group 120a, and a t-th random seed value key kₜ₋₁ is assigned to a t-th node 126 in node group 120a.

As illustrated in FIG. 5, hash chains are generated based on a hash function and random seed value keys k₀, . . . , kₜ₋₁ corresponding to second middle nodes 121, . . . , 126 in node group 120a. For example, if the hash function is an one-way (e.g., a counterclockwise) hash function, a first hash chain for the first random seed value key k₀ may be defined as {k₀, h(k₀), h(h(k₀))=h²(k₀), h³(k₀), . . . , h^{(t-2)}(k₀), h^{(t-1)}(k₀)}. Similarly, second through t-th hash chains for second through t-th random seed value keys k₁, . . . , kₜ₋₁ may be defined, respectively.

Referring to FIG. 6, “t” values in each hash chain may be mapped into second middle nodes 121, . . . , 126, respectively. For example, in the first hash chain, first random seed value key k₀ may be assigned to first node 121 in node group 120a, a value h(k₀) (generated by hashing k₀) may be assigned to the second node 122 in node group 120a, and a value h^{(t-1)}(k₀) (generated by hashing h^{(t-2)}(k₀)) may be assigned to the t-th node 126 in node group 120a. Similarly, in the second hash chain, the second random seed value key k₁ may be assigned to second node 122 in node group 120a, a value h(k₁) (generated by hashing k₁) may be assigned to a third node 123 in node group 120a, and a value h^{(t-1)}(k₁) (generated by hashing h^{(t-2)}(k₁)) may be assigned to first node 121 in node group 120a. In the t-th hash chain, the t-th random seed value key kₜ₋₁ may be assigned to the t-th node 126 in node group 120a, a value h(kₜ₋₁) (generated by hashing kₜ₋₁) may be assigned to first node 121 in node group 120a, and a value h^{(t-1)}(kₜ₋₁) (generated by hashing h^{(t-2)}(kₜ₋₁)) may be assigned to a (t−1)-th node 125 in node group 120a.

In some embodiments, a node key set for a node is generated by combining values assigned to the node. For example, a first node key set for first node 121 may be generated by combining t values k₀, h^{(t-1)}(k₁), h^{(t-2)}(k₂), h^{(t-3)}(k₃), . . . , h²(kₜ₋₂), h(kₜ₋₁) assigned to first node 121. Such a scheme that generates the node key sets based on the hash function and the hash chains may be referred to as a hierarchical hash chain broadcast encryption scheme (HBES) algorithm. The node key sets for all second middle nodes MN2 and the node key sets for all leaf nodes LN may be generated based on the HBES algorithm.

Referring again to FIG. 2, the node key sets for all nodes in node groups 120a, 130a in lower layers LAYER2, . . . , LAYER(d−1) may be determined based on the scheme described with reference to FIGS. 3, 4, 5 and 6. The device keys for the devices may be determined based on the node key sets for the second middle nodes MN2 and leaf nodes LN in node groups 120a, 130a in lower layers LAYER2, . . . , LAYER(d−1). For example, in a first device arranged corresponding to a first leaf node 14 among leaf nodes LN, a first device key for the first device may be generated based on a first node key set for the first leaf node 14 and second node key sets for first ancestor nodes 12, 13. First ancestor nodes 12, 13 may be a part of whole ancestor nodes 10, 11, 12, 13 of first leaf node 14 and may be in second middle nodes MN2. In other words, the first device key for the first device may be generated based on nodes 12, 13, 14 that have the node key sets and except the nodes 10, 11 that do not have the node key sets, among nodes 10, 11, 12, 13, 14.

To compare the method of FIG. 1 with a conventional method, suppose that a depth of the tree structure is about 10 and a size of a single node key set is about 256 bytes. In the conventional method, a device key may be generated by combining 10 node key sets and may have a size of about 2560 bytes. However, in the method of FIG. 1, a device key may be generated by combining 8 node key sets and may have a size of about 2048 bytes where the tree structure is classified into two upper layers and eight lower layers, as illustrated in FIG. 2. In the method of FIG. 1, a size of a device key is reduced as the number of layers that do not have the node key sets (e.g., the upper layers) increases.

In various alternative embodiments, the depth of the tree structure, the number of nodes in a single node group, and the number of layers that do not have the node key sets may vary.

FIG. 7 is a diagram illustrating another example tree structure for the method of FIG. 1, according to an embodiment of the inventive concept. In the example tree structure of FIG. 7, nodes in the same node group are disposed in a linear configuration.

Referring to FIGS. 1 and 7, the tree structure of FIG. 7 is substantially the same as the tree structure of FIG. 2, except that nodes in the same node group among node groups 110b, 120b, 130b are disposed in the linear configuration. The tree structure comprises a root node RN, a plurality of middle nodes, and a plurality of leaf nodes LN. The middle nodes comprise first middle nodes MN1 and second middle nodes MN2. The tree structure comprises a plurality of layers LAYER0, LAYER1, LAYER2, . . . , LAYER(d−2), LAYER(d−1). Each of layers LAYER0, . . . , LAYER(d−1) comprises at least one of node groups 110b, 120b, 130b. Each of node groups 110b, 120b, 130b comprises at least two of middle nodes MN1, MN2, and leaf nodes LN. First nodes in the same node group among node groups 110b, 120b, 130b may be in the same layer of layers LAYER0, . . . , LAYER(d−1), and the same ancestor nodes may be shared by the first nodes.

First middle nodes MN1, which are omitted the determination of the node key sets, are included in at least one upper layer (e.g., LAYER0, LAYER1) adjacent to root node RN. Second middle nodes MN2, which are determined the node key sets, are included in lower layers (e.g., LAYER2, . . . , LAYER(d−2)) under the at least one upper layer. The node key sets for all second middle nodes MN2 and all leaf nodes LN in node groups 120b, 130b in lower layers LAYER2, . . . , LAYER(d−1) can be determined based on a scheme similar to that described above with reference to FIGS. 3, 4, 5 and 6. Device keys for the devices may be determined based on the node key sets for the second middle nodes MN2 and leaf nodes LN.

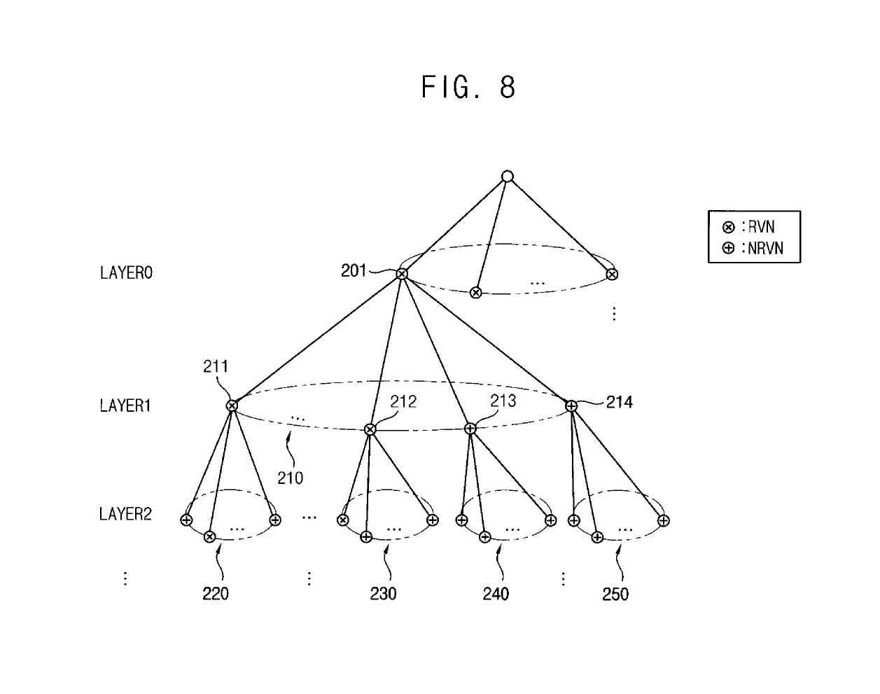

FIGS. 8, 9 and 10 are diagrams for describing the method of FIG. 1, according to an embodiment of the inventive concept.

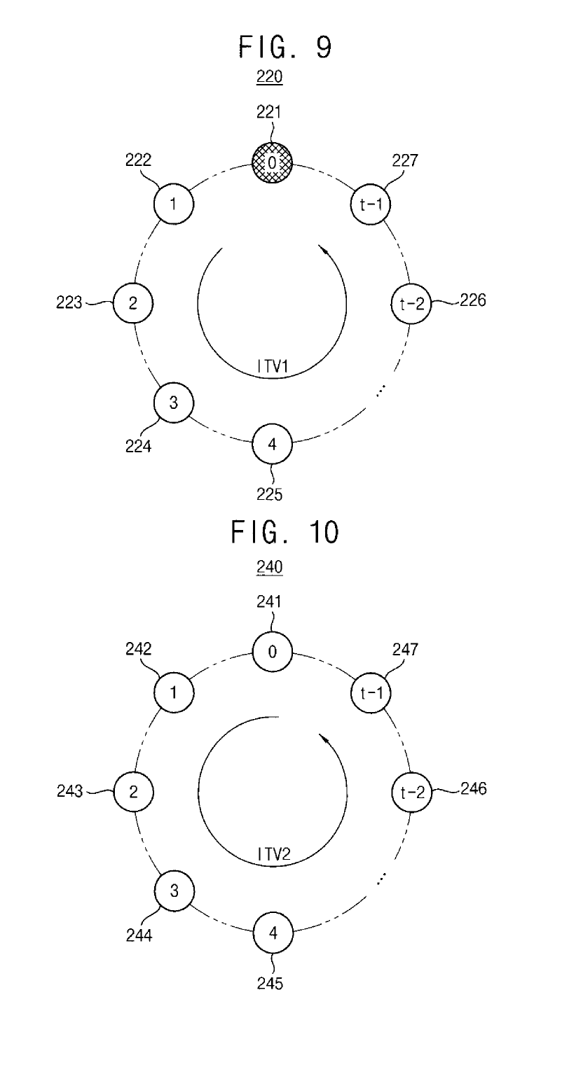

FIG. 8 illustrates another example of the tree structure where nodes in the same node group are disposed in the circular configuration. FIGS. 9 and 10 illustrate examples of node groups in the tree structure of FIG. 8. It is assumed that the node key sets and the device keys are determined based on the scheme described above with reference to FIGS. 2, 3, 4, 5 and 6. In other words, in FIGS. 8, 9 and 10, the determination of the node key sets for the first middle nodes in the upper layers LAYER0, LAYER1 may be omitted, the node key sets for the second middle nodes and the leaf nodes in the lower layers LAYER2, . . . , LAYER(d−1) may be determined, and the device keys for the devices may be determined based on the node key sets for the second middle nodes and the leaf nodes. For convenience of illustration, FIG. 8 illustrates only the root node and first through third layers LAYER0, LAYER1, LAYER2.

Referring to FIGS. 8, 9 and 10, nodes in the tree structure may be classified into revoked nodes RVN and non-revoked nodes NRVN. A non-revoked node NRVN corresponds to user in a user group (e.g. an authorized user), and a revoked node RVN corresponds to a user excluded from the user group (e.g. an illegal user). In the example of FIG. 8, all nodes in first layer LAYER0 are revoked nodes RVN. Among nodes included in second layer LAYER1 and directly descendant from a node 201, first through (t−2)-th nodes 211, . . . , 212 are revoked nodes RVN, and (t−1)-th and t-th nodes 213, 214 are non-revoked nodes NRVN. Nodes included in third layer LAYER2 and directly descendant from nodes 211, 212, 213, 214 may be one of revoked nodes RVN and non-revoked node NRVN, respectively.

Hereinafter, a method of defining an interval in the node group will be described with reference to FIGS. 8, 9 and 10. The interval may be used for transmitting a broadcast message to the non-revoked nodes sharing node 201.

In some embodiments, where a first node group comprises at least one revoked node, a first interval may be defined based on consecutive non-revoked nodes in the first node group except the at least one revoked node. For example, a node group 220 comprises nodes 221, 222, 223, 224, 225, . . . , 226, 227 that are directly descendant from node 211, as illustrated in FIGS. 8 and 9. Node 221 in node group 220 may be revoked node RVN, and other nodes 222, . . . , 227 in node group 220 may be non-revoked nodes NRVN. In this case, consecutive non-revoked nodes 222, . . . , 227 in node group 220, except revoked node 221, may be defined as first interval ITV1. First interval ITV1 may be defined from the node 222 to the node 227 because the hash chains may be generated based on the counterclockwise hash function, as described above with reference to FIGS. 5 and 6.

First interval ITV1 in the node group 220 may be used for transmitting the broadcast message to the nodes sharing the node 211. The broadcast message may be effectively transmitted to the non-revoked nodes 222, . . . , 227 and may not be effectively transmitted to revoked node 221, based on a hash chain that corresponds to a random seed value key (e.g., the random seed value key k₁) assigned to the start node 222 of first interval ITV1. For example, the broadcast message may be transmitted to the nodes 221, . . . , 227 by using a value h^{(t-2)}(k₁), which is one oft values mapped into the end node 227 of first interval ITV1 and is generated based on the random seed value key k₁. In other words, if it is assumed that K is a key, M is an original message and “E(K, M)” is an encrypted message by K, the encrypted broadcast message “E(h^{(t-2)}(k₁), M)” may be transmitted to the nodes 221, . . . , 227 in the node group 220.

Non-revoked nodes 222, . . . , 227 may obtain the value h^{(t-2)}(k₁) using the hash function and the assigned values (e.g., k₁, . . . , h^{(t-2)}(k₁)). However, the revoked node 221 may not obtain the value h^{(t-2)}(k₁) using the hash function and the assigned value h^{(t-1)}(k₁) because the hash function is the one-way (e.g., the counterclockwise) function. As a result, first devices that correspond to descendant nodes of the non-revoked nodes 222, . . . , 227 may decrypt the encrypted broadcast message “E(h^{(t-2)}(k₁), M)” by obtaining the key h^{(t-2)}(k₁), and second devices that correspond to descendant nodes of the revoked nodes 221 may not decrypt the encrypted broadcast message “E(h^{(t-2)}(k₁), M)” because the second devices can not obtain the key h^{(t-2)}(k₁).

Although not illustrated in FIG. 9, more than two intervals may be defined in a single node group. For example, if the nodes 221, 224 are the revoked nodes and the other nodes 222, 223, 225, . . . , 227 are the non-revoked nodes in the node group 220 of FIG. 9, one interval may be defined from the node 222 to the node 223 and another interval may be defined from the node 225 to the node 227. Similarly, a node group 230 may include nodes that are directly descendant from node 212. Consecutive non-revoked nodes in node group 230, except at least one revoked node, may be defined as an additional first interval. The additional first interval in the node group 230 may be used for transmitting the broadcast message to the nodes sharing the node 212.

In FIG. 8, if non-revoked nodes 213, 214 in a node group 210 of second layer LAYER1 are defined as one interval, the broadcast message may be transmitted to the nodes sharing the nodes 213, 214 based on the interval including the nodes 213, 214. However, it is not possible to define the interval including the non-revoked nodes 213, 214 because the nodes 213, 214 in second layer LAYER1 are the first middle nodes that do not have the node key sets. Thus, another method for transmitting the broadcast message to the nodes sharing the nodes 213, 214 may be required.

In some embodiments, where a first node among the first middle nodes corresponds to the non-revoked node, all second nodes that are directly descendant from the first node and form a second node group, among the second middle nodes, may correspond to the non-revoked nodes. A second interval can be defined based on consecutive non-revoked nodes in the second node group even if the second node group does not include the revoked node. For example, a node group 240 may include nodes 241, 242, 243, 244, 245, . . . , 246, 247 that are directly descendant nodes of the node 213, as illustrated in FIGS. 8 and 10. Where node 213 among the first middle nodes in second layer LAYER1 is the non-revoked node, all nodes 241, . . . , 247, which are directly descendant nodes of the node 213 and form node group 240, of the second middle nodes in third layer LAYER2 may be the non-revoked nodes. In this case, the consecutive non-revoked nodes 241, . . . , 247 in node group 240 may be defined as second interval ITV2 even if node group 240 does not include revoked node RVN. Second interval ITV2 may be defined from node 241 to node 247.

Second interval ITV2 in node group 240 may be used for transmitting the broadcast message to the nodes sharing node 213. The broadcast message may be effectively transmitted to non-revoked nodes 241, . . . , 247 based on a hash chain that corresponds to a random seed value key (e.g., the random seed value key k₀) assigned to the start node 241 of second interval ITV2. For example, the broadcast message may be transmitted to nodes 241, . . . , 247 using a value h^{(t-1)}(k₀), which is one oft values mapped into the end node 247 of second interval ITV2 and is generated based on the random seed value key k₀. In other words, the encrypted broadcast message “E(h^{(t-1)}(k₀), M)” may be transmitted to nodes 241, . . . , 247 in node group 240. Non-revoked nodes 241, . . . , 247 may obtain the value h^{(t-1)}(k₀) using the hash function and the assigned values (e.g., k₀, . . . , h^{(t-1)}(k₀)). As a result, devices that correspond to descendant nodes among non-revoked nodes 241, . . . , 247 may decrypt the encrypted broadcast message “E(h^{(t-1)}(k₀), M)” by obtaining the key h^{(t-1)}(k₀).

Similarly, a node group 250 may include nodes that are directly descendant from node 214. Consecutive non-revoked nodes in the node group 250 may be defined as an additional second interval. The additional second interval in the node group 250 may be used for transmitting the broadcast message to the nodes sharing the node 214.

In the method of managing keys for broadcast encryption according to example embodiments, although it is impossible to define the first interval in a node group (e.g., the node group 210 in FIG. 8) having the first middle nodes, the second interval may be defined in a node group (e.g., the node groups 240, 250 in FIG. 8) having the second middle nodes that are directly descendant nodes of the first middle node. For example, the consecutive non-revoked nodes in the node groups 240, 250 may be defined as the second interval even if the node groups 240, 250 do not include the revoked node.

As described above, the broadcast message may be transmitted to the nodes (e.g., the leaf node) sharing the nodes 201, 211, 212 based on the first interval (e.g., a set of consecutive non-revoked nodes in a single node group except at least one revoked node when the single node group includes the at least one revoked node), and the broadcast message may also be transmitted to the nodes (e.g., the leaf node) sharing the nodes 201, 213, 214 based on the second interval (e.g., a set of consecutive non-revoked nodes in a single node group when the single node group does not include a revoked node). Accordingly, the broadcast message may be effectively transmitted to the non-revoked nodes of the leaf nodes sharing the node 201.

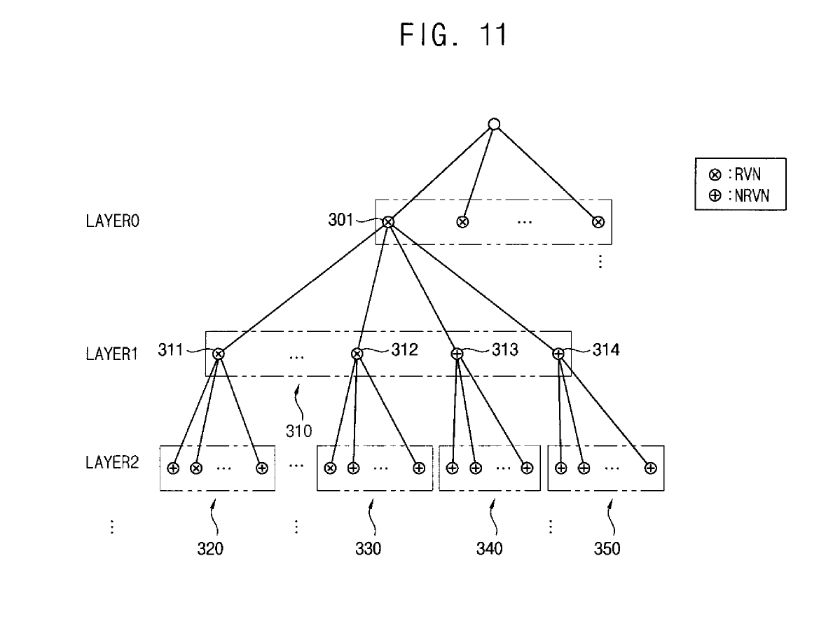

FIGS. 11, 12 and 13 are diagrams for describing the method of managing keys for broadcast encryption of FIG. 1.

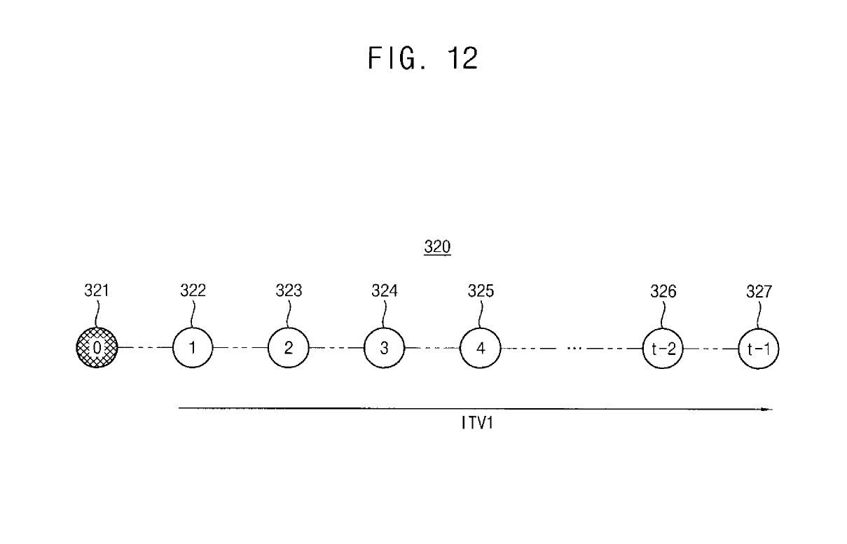

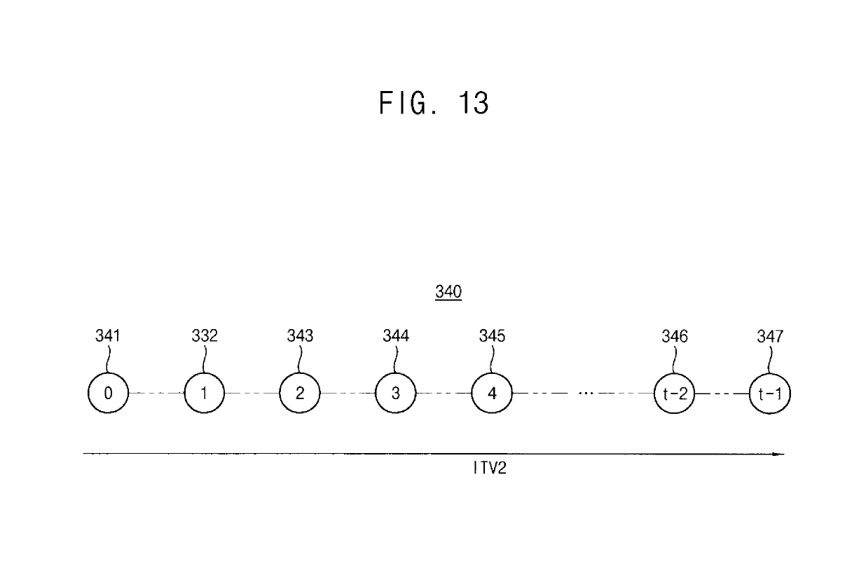

FIG. 11 illustrates another example of the tree structure such that nodes in the same node group are disposed in the linear configuration. FIGS. 12 and 13 illustrate examples of the node groups in the tree structure of FIG. 11. The tree structure of FIG. 11 may be substantially the same as the tree structure of FIG. 8 except that the nodes in the same node group are disposed in the linear configuration. In other words, in FIGS. 11, 12 and 13, the determination of the node key sets for the first middle nodes in the upper layers LAYER0, LAYER1 may be omitted, the node key sets for the second middle nodes and the leaf nodes in the lower layers LAYER2, . . . , LAYER(d−1) may be determined, and the device keys for the devices may be determined based on the node key sets for the second middle nodes and the leaf nodes. For convenience of illustration, FIG. 11 illustrates only the root node and first through third layers LAYER0, LAYER1, LAYER2.

Referring to FIGS. 11, 12 and 13, the nodes in the tree structure may be classified as revoked nodes RVN and non-revoked nodes NRVN. In an example of FIG. 11, all nodes in the first layer LAYER0 may be the revoked nodes RVN. Among nodes included in second layer LAYER1 and directly descendant from a node 301, nodes 311, . . . , 312 may be the revoked nodes RVN, and nodes 313, 314 may be the non-revoked nodes NRVN. Nodes included in third layer LAYER2 and directly descendant from nodes 311, 312, 313, 314 may be one of the revoked nodes RVN and the non-revoked node NRVN, respectively.

A node group 320 may include nodes 321, 322, 323, 324, 325, . . . , 326, 327 that are directly descendant nodes of the node 311, as illustrated in FIGS. 11 and 12. The node 321 in the node group 320 may be revoked node RVN, and other nodes 322, . . . , 327 in the node group 320 may be the non-revoked nodes NRVN. In this case, the consecutive non-revoked nodes 322, . . . , 327 in the node group 320, except the revoked node 321, may be defined as first interval ITV1. Similarly, consecutive non-revoked nodes in a node group 330, except at least one revoked node, may be defined as an additional first interval. First interval ITV1 in node group 320 and the additional first interval in node group 330 can be used for transmitting the broadcast message to nodes sharing the node 311 and the node 312, respectively.

A node group 340 comprises nodes 341, 342, 343, 344, 345, . . . , 346, 347 that are directly descendant nodes of the node 313, as illustrated in FIGS. 11 and 13. Where node 313 among the first middle nodes in second layer LAYER1 is the non-revoked node, all nodes 341, . . . , 347, which are directly descendant nodes of the node 313 and form node group 340, of the second middle nodes in third layer LAYER2 may be the non-revoked nodes. In this case, the consecutive non-revoked nodes 341, . . . , 347 in node group 340 may be defined as second interval ITV2 even if node group 340 does not include revoked node RVN. Similarly, consecutive non-revoked nodes in a node group 350 may be defined as an additional second interval. Second interval ITV2 in node group 340 and the additional second interval in node group 350 may be used for transmitting the broadcast message to nodes sharing node 313 and node 314, respectively.

As described above, the broadcast message may be transmitted to the leaf nodes sharing nodes 301, 311, 312 based on the first interval, and the broadcast message may be transmitted to the leaf nodes sharing the nodes 301, 313, 314 based on the second interval. Accordingly, the broadcast message may be effectively transmitted to the non-revoked nodes of the leaf nodes sharing node 301.

According to some embodiments, the number of revoked nodes and non-revoked nodes in a single node group and the number of intervals in a single node group may be changed.

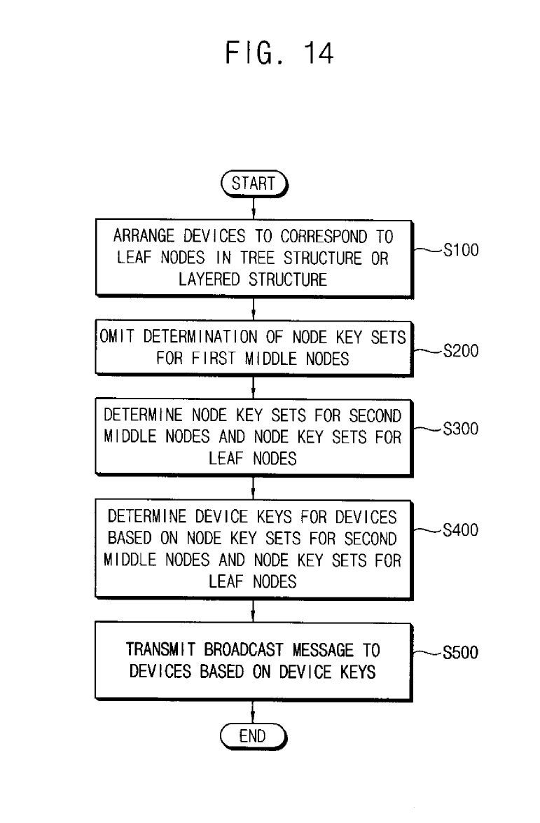

FIG. 14 is a flowchart illustrating a method of transmitting messages using broadcast encryption, according to an embodiment of the inventive concept.

Referring to FIG. 14, operations S100 through S400 are performed as described above in relation to FIG. 1. Thereafter, a broadcast message is transmitted to the devices based on the device keys (S500). For example, as described above with reference to FIGS. 2 and 7, the tree structure may include a plurality of layers. Each layer may include at least one of a plurality of node groups, and each node group may include at least two of the middle nodes and the leaf nodes. As described above with reference to FIGS. 8 through 13, the nodes may be classified into revoked nodes and non-revoked nodes. Where a first node group of node groups includes at least one revoked node, a first interval may be defined based on consecutive non-revoked nodes in the first node group except the at least one revoked node. Where a first node among the first middle nodes corresponds to the non-revoked node, second nodes, which are directly descendant nodes of the first node and form a second node group, of the second middle nodes correspond to the non-revoked nodes. A second interval may be defined based on consecutive non-revoked nodes in the second node group even if the second node group does not include the revoked node. In this case, the broadcast message may be transmitted to the devices based on the first interval and the second interval.

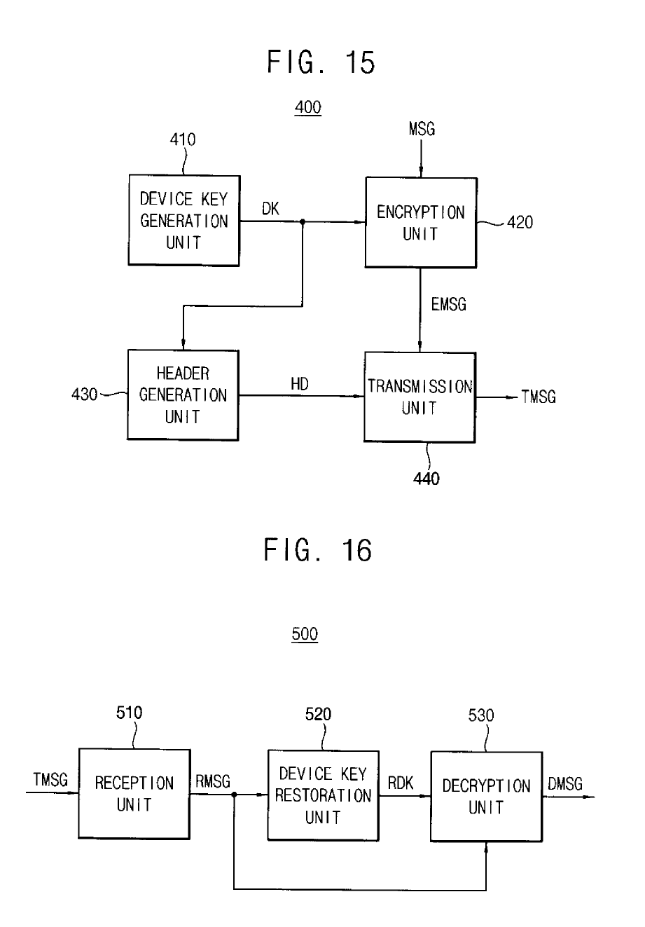

FIG. 15 is a block diagram illustrating a broadcast encryption device according to an embodiment of the inventive concept.

Referring to FIG. 15, a broadcast encryption device 400 comprises a device key generation unit 410, an encryption unit 420, a header generation unit 430 and a transmission unit 440.

Device key generation unit 410 generates device keys DK for a plurality of devices, and stores device keys DK. Device keys DK may be generated based on the method described above with reference to FIGS. 1 through 13. For example, the devices may be arranged to correspond to a plurality of leaf nodes in a tree structure. The tree structure may include a plurality of nodes having a root node, a plurality of middle nodes and the leaf nodes. Determination of node key sets for first middle nodes of the middle nodes may be omitted, and node key sets for second middle nodes of the middle nodes and node key sets for the leaf nodes may be determined. Device keys DK for the devices may be determined based on the node key sets for the second middle nodes and the node key sets for the leaf nodes. Accordingly, the device keys DK may have relatively small sizes.

Encryption unit 420 generates an encrypted message EMSG by encrypting a broadcast message MSG based on the device keys DK. Header generation unit 430 generates a message header HD based on device keys DK. Transmission unit 440 generates a transmission message TMSG based on message header HD and encrypted message EMSG, and transmits transmission message TMSG to a broadcast decryption device.

FIG. 16 is a block diagram illustrating a broadcast decryption device, according to an embodiment of the inventive concept.

Referring to FIG. 16, a broadcast decryption device 500 comprises a reception unit 510, a device key restoration unit 520 and a decryption unit 530.

Reception unit 510 receives transmission message TMSG (e.g., from broadcast encryption device 400 of FIG. 15) and generates a reception message RMSG. Device key restoration unit 520 generates restored device keys RDK based on the reception message RMSG. For example, device key restoration unit 520 may generate restored device keys RDK based on message header HD in the transmission message TMSG corresponding to the reception message RMSG. Device key restoration unit 520 stores original device keys (e.g., the device keys DK in FIG. 15) and compares the restored device keys RDK with the original device keys. Decryption unit 530 generates a decrypted message DMSG based on restored device keys RDK and reception message RMSG. Decrypted message DMSG may be substantially the same as broadcast message MSG in FIG. 15.

In some embodiments, broadcast encryption device 400 of FIG. 15 and broadcast decryption device 500 of FIG. 16 are included in a broadcast encryption system. In this case, the broadcast encryption device 400 may correspond to a host (e.g., a provider or a broadcasting center) that supplies broadcast messages and/or contents, and broadcast decryption device 500 may correspond to a user that receives broadcast messages and/or contents.

In some embodiments, at least a portion of the device key generation unit, the encryption unit, the header generation unit and the transmission unit described with reference to FIG. 15 and at least a portion of the reception unit, the device key restoration unit and the decryption unit described with reference to FIG. 16 may be implemented as hardware. In other embodiments, at least a portion of the device key generation unit, the encryption unit, the header generation unit and the transmission unit described with reference to FIG. 15 and at least a portion of the reception unit, the device key restoration unit and the decryption unit described with reference to FIG. 16 may be implemented as software and may be stored in a storage in a form of program codes that may be executed by a processor (e.g., a microprocessor, a central processing unit (CPU), etc.).

The above described embodiments can be applied in many contexts, with examples including secure flash devices using broadcast encryption and electronic systems having secure flash devices. Examples of such electronic systems include mobile phones, smart phones, personal digital assistants (PDAs), portable multimedia player (PMPs), digital cameras, camcorders, personal computers (PCs), server computers, workstations, laptops, digital televisions, set-top-boxes, music players, portable game consoles, navigation systems, and/or printers.

The foregoing is illustrative of embodiments and is not to be construed as limiting thereof. Although a few embodiments have been described, those skilled in the art will readily appreciate that many modifications are possible in the embodiments without departing from the scope of the inventive concept as defined in the claims.

What is claimed is:

1. A method of managing keys for broadcast encryption, comprising:
identifying a plurality of devices as corresponding to a plurality of leaf nodes in a tree structure comprising a plurality of nodes having a root node, a plurality of middle nodes, and the leaf nodes, the plurality of middle nodes comprising first middle nodes and second middle nodes;
determining node key sets for the second middle nodes and for the leaf nodes and omitting a determination of node key sets for first middle nodes of the middle nodes; and
determining device keys for the plurality of devices based on the node key sets for the second middle nodes and the node key sets for the leaf nodes.

2. The method of claim 1, wherein the first middle nodes each have a distance from the root node that is less than a predetermined value, and second middle nodes each have a distance from the root node that is greater than or equal to the predetermined value.

3. The method of claim 2, wherein the tree structure comprises a plurality of layers, each layer comprising at least one of a plurality of node groups, and each node group comprising at least two of the middle nodes and the leaf nodes,
wherein the plurality of layers comprises at least one upper layer adjacent to the root node and one lower layer separated from the root node by the at least one upper layer, the first middle nodes are in the at least one upper layer, and the second middle nodes are in the lower layers.

4. The method of claim 3, wherein the nodes are classified as revoked nodes and non-revoked nodes, and
wherein when a first node group among node groups comprises at least one revoked node, a first interval is defined based on consecutive non-revoked nodes in the first node group other than the at least one revoked node.

5. The method of claim 4, wherein where a first node among the first middle nodes corresponds to the non-revoked node, second nodes among the second middle nodes correspond to the non-revoked nodes, wherein the second nodes are directly descendant nodes among the first node and form a second node group.

6. The method of claim 5, wherein a second interval is defined based on consecutive non-revoked nodes in the second node group and the second node group does not include the revoked node.

7. The method of claim 3, wherein first nodes in the same node group are in the same layer, and the same ancestor nodes are shared by the first nodes.

8. The method of claim 3, wherein first nodes in the same node group are disposed in a circular configuration.

9. The method of claim 3, wherein first nodes in the same node group are disposed in a linear configuration.

10. The method of claim 3, wherein determining the node key sets for the second middle nodes and the node key sets for the leaf nodes comprises:
assigning random seed value keys to the second middle nodes and the leaf nodes; and
generating the node key sets for the second middle nodes and the node key sets for the leaf nodes based on the random seed value keys.

11. The method of claim 10, wherein generating the node key sets for the second middle nodes and the node key sets for the leaf nodes comprises:
where first nodes in the same node group are disposed in a circular configuration, generating first node key sets for the first nodes based on first random seed value keys corresponding to the first nodes, the first node key sets being constructed in a hash chain.

12. The method of claim 11, wherein the node key sets for the second middle nodes and the node key sets for the leaf nodes are generated based on a hierarchical hash chain broadcast encryption scheme (HBES) algorithm.

13. The method of claim 3, wherein determining the device keys for the devices comprises:
generating a first device key for a first device based on a first node key set and second node key sets, the first node key set being a node key set for a first leaf node corresponding to the first device, the second node key sets being node key sets for first ancestor nodes of the first leaf node, the first ancestor nodes being in the second middle nodes.

14. The method of claim 1, further comprising transmitting a broadcast message to the devices based on the device keys.

15. The method of claim 14, wherein the tree structure comprises a plurality of layers each comprising at least one of a plurality of node groups, and each node group comprises at least two of the middle nodes and the leaf nodes, wherein the nodes are classified as revoked nodes and non-revoked nodes,
wherein where a first node group of node groups comprises at least one revoked node, a first interval is defined based on consecutive non-revoked nodes in the first node group other than the at least one revoked node,
wherein where a first node among the first middle nodes corresponds to the non-revoked node, second nodes among the second middle nodes correspond to the non-revoked nodes, wherein the second nodes are directly descendant nodes of the first node and form a second node group, and wherein a second interval is defined based on consecutive non-revoked nodes in the second node group even if the second node group does not include the revoked node.

16. The method of claim 15, wherein transmitting the broadcast message to the devices comprises transmitting the broadcast message to the devices based on the first interval and the second interval.

17. A system configured to manage keys for broadcast encryption, comprising:
a tree structure comprising a plurality of nodes having a root node, a plurality of middle nodes, and a plurality of leaf nodes, the plurality of middle nodes comprising first middle nodes and second middle nodes;
a plurality of devices corresponding to the plurality of leaf nodes;
a controller configured to determine node key sets for the second middle nodes and for the leaf nodes, to omit a determination of node key sets for first middle nodes of the middle nodes, and to determine device keys for the plurality of devices based on the node key sets for the second middle nodes and the node key sets for the leaf nodes.

18. The system of claim 17, further comprising a broadcast center configured to transmit a broadcast message to the devices based on the device keys.

19. The system of claim 17, wherein the devices are arranged in a secure flash device.

20. The system of claim 17, wherein the first middle nodes each have a distance from the root node that is less than a predetermined value, and second middle nodes each have a distance from the root node that is greater than or equal to the predetermined value.
